(19) United States
(12) Patent Application Publication
(10) Pub. No.: US 2019/0029777 A1
(43) Pub. Date: Jan. 31, 2019

(54) FIXTURE HAVING HEXAGONAL FEMALE SCREW PART

(71) Applicant: Young Jae KIM, Seoul (KR)

(72) Inventor: Young Jae KIM, Seoul (KR)

(21) Appl. No.: 16/071,882

(22) PCT Filed: Jan. 19, 2017
(86) PCT No.: PCT/KR2017/000665

§ 371 Date: Jul. 20, 2018

(30) Foreign Application Priority Data
Jan. 21, 2016 (KR) 10-2016-0007323

(51) Int. Cl. A61C 8/00

(52) U.S. Cl. CPC A61C 8/006; A61C 8/0068

(57) ABSTRACT

The prevent invention relates to: a fixture; a fixing groove formed in the fixture, wherein an abutment is inserted in the fixing groove; a female screw part of the fixture for coupling the abutment to a lower part of the fixing groove; and the abutment having a hexagonal screw thread, the abutment having a male screw part formed at a body of a lower part of the abutment corresponding to the fixing groove to be coupled with the fixing groove, wherein the female screw part has a hexagonal internal shape, and a screw root of the female screw part is configured to be a circular screw part maintaining a circular shape of the screw root.

### TECHNICAL FIELD

The present invention relates to a dental implant in which one fixture can be used for two sorts of abutments.

### DESCRIPTION OF THE RELATED ART

Conventionally, in the case of a dental implant, an abutment is screwed into and fixed to a fixture such that the abutment is firmly fixed to the fixture for a long time.

However, a screw-type abutment is not appropriate for a molar tooth because the screw-type abutment can rotate when people grind their teeth unknowingly and chew food. Accordingly, in the case of a screw coupling, an abutment often escapes from a fixture. The present invention is devised to solve such a problem.

In the case of a dental implant, two sorts of abutments are required.

This applicant has devised a hexagonal abutment that is press-fitted with and fixed to a fixture and is appropriate for a molar tooth.

Further, four kinds of tools are needed to use a rotational screw-shaped abutment, a hexagonal abutment, a screw-shaped fixture, and a hexagonal fixture. However, this applicant has devised a fixture to which two sorts of abutments are fixed.

### DETAILED DESCRIPTION FOR THE INVENTION

### Technical Problems

In the case of a molar implant, an abutment often escapes from a fixture.

As a means to prevent an abutment from escaping from a fixture, the present invention provides a fixture into which two sorts of abutments may be inserted and fixed.

Accordingly, an abutment for a front tooth implant has to be different from an abutment for a molar implant.

The present invention is directed to providing a more solid fixture which can maintain solidity both for a front tooth implant that is rotated and inserted and a molar implant that is press-fitted.

### Technical Solutions

As a means to solve the above-described problems, the present invention is configured as follows.

A fixing groove, into which an abutment is inserted, is formed inside a fixture.

A female screw part of the fixture is formed at the lower portion of the fixing groove so as to be couple to the abutment.

A male screw part is formed at the lower portion of the abutment so as to be coupled to the fixing groove.

The female screw part is configured to have a hexagonal internal shape, and a screw root of the female screw part is configured to be a circular screw part maintaining a circular shape.

A portion with the longest screw thread out of screw threads of the female screw part is a middle portion of an edge and an edge of a hexagonal shape.

The longest screw thread is configured to be long enough to be coupled to the screw root of the male screw part formed at the lower portion of the abutment.

Herein, a hexagonal edge of the female screw part of the fixture is a portion with the shortest screw thread.

### Advantageous Effects

Regardless of the shape of the abutment such as a circular screw shape or a hexagonal shape, one fixture may be used for two sorts of abutments.

### BRIEF DESCRIPTION OF THE DRAWINGS

FIG. 1 is a view illustrating a hexagonal groove of a hole inside a fixture.

FIG. 2 is a view illustrating a female screw part in the hexagonal groove in FIG. 1.

FIG. 3 is a view illustrating a lower portion of an abutment, which is configured to be a circular screw part.

FIG. 4 is a view illustrating a lower portion of an abutment, which is configured to have a hexagonal shape.

FIG. 5 is a block diagram illustrating a combination of FIGS. 2 and 3.

FIG. 6 is a block diagram illustrating a combination of FIGS. 2 and 4.

### BEST MODE FOR CARRYING OUT THE INVENTION

A hexagonal abutment in FIG. 4 is preferably used for molar teeth.

In the case of a molar implant, a hexagonal abutment 230 is press-fitted with and fixed to a fixture.

Although molar teeth are generally to chew and grind down food into small pieces, molar teeth tend to rotate depending on a person's habit.

Accordingly, if an abutment of a dental implant corresponding to a molar tooth is configured to have a circular screw part, the abutment might rotate and escape from a fixture.

In the case of a dental implant corresponding to a front tooth, the dental implant does not escape although it is rotated and inserted.

As a result, two sorts of abutments are needed for dental implants.

FIG. 2 is a view illustrating two sorts of abutments inserted into one fixture performing two functions.

According to the present invention, two sorts of abutments may be inserted into one fixture that has a female screw part with a hexagonal shape.

### Mode for Carrying out the Invention

The present invention provides a fixture which has a hexagonal groove with a female screw part therein such that a lower portion of an abutment with a circular screw shape or a hexagonal shape is inserted into the fixture.

The present invention will be described as follows with reference to the attached drawings.

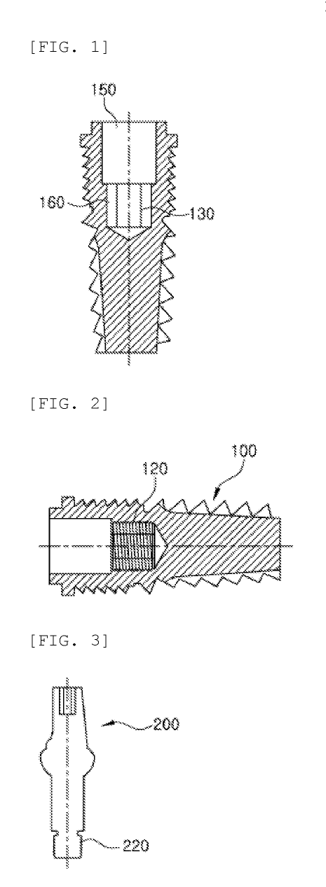

FIGS. 1 and 2 are views illustrating a hexagonal fixing groove with a female screw part.

The present invention will be described according to FIG. 1.

The fixing groove 150, into which an abutment is inserted, is formed inside a fixture 100.

A lower portion of the fixing groove is configured to have a hexagonal shape.

FIG. 2 is a view illustrating a hexagonal fixing groove 160 with a female screw part 120.

FIG. 3 is a view illustrating an abutment with a circular screw part 220.

FIG. 3 is a view illustrating an abutment coupled to a female screw part of a fixing groove.

The fixing groove of the fixture is configured to have a hexagonal internal shape 130 and to have a screw root of the female screw part.

Accordingly, regardless of the shape of the abutment such as a circular screw shape or a hexagonal shape, which is coupled to the fixture, one fixture may be used for two sorts of abutments.

An abutment with the circular screw part 220 are used for a dental implant corresponding to a front tooth.

Front teeth move up and down to cut food. Accordingly, the abutment that is rotated and fixed may be semi-permanently used for dental implants corresponding to front teeth.

A hexagonal abutment in FIG. 4 is preferably used for a dental implant corresponding to a molar tooth.

In the case of a molar implant, the hexagonal abutment 230 is press-fitted with and fixed to a fixture.

The present invention will be described as follows with reference to FIGS. 4 to 6.

A portion with the longest screw thread of the screw threads of the female screw part 230 of the fixture formed in a hexagonal shape is a middle portion of an edge and an edge of the hexagonal shape.

A portion with the longest screw thread of the screw threads of the fixture corresponds to a screw root of a male screw part formed at the lower portion of the abutment.

Although molar teeth are generally to chew and grind down food into small pieces, molar teeth tend to rotate depending on a person's habit.

Accordingly, if an abutment of a dental implant corresponding to a molar tooth is configured to have a circular screw part, the abutment might rotate and escape from a fixture.

As a result, two sorts of abutments are needed for dental implants.

The present invention relates to a fixture into which two sorts of abutments are inserted.

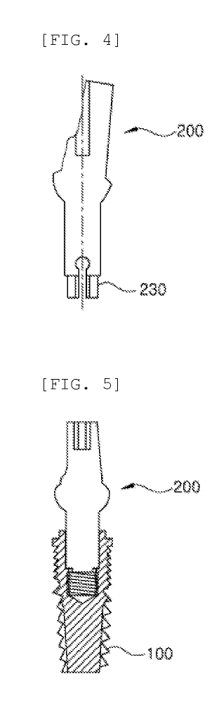

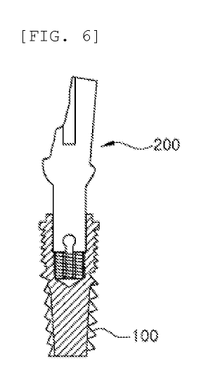

FIGS. 5 and 6 are views illustrating two sorts of abutments inserted into one fixture performing two functions.

A portion with the longest screw thread of the screw threads of the female screw part of the fixture is a middle portion of an edge and an edge of a hexagonal shape.

On the contrary, a portion with the shortest screw thread is a hexagonal edge of the female screw part of the fixture.

In the case of the fixture with the above-described configuration, two sorts of abutments may be inserted into one fixture.

### INDUSTRIAL APPLICABILITY

In the case of a dental implant, an abutment is screwed into and fixed to a fixture such that the abutment is firmly fixed to the fixture for a long time.

However, in the case of a dental implant, two sorts of abutments such as a screw shape and a hexagonal shape are required.

Four kinds of tools are needed to use a rotational screw-shaped abutment, a hexagonal abutment, a screw-shaped fixture, and a hexagonal fixture. The present invention is devised to solve this problem.

That is, the present invention provides a fixture to which two sorts of abutments are fixed. Accordingly, the present invention is industrially applicable.

1. A fixture having a hexagonal female screw part comprising:
a fixture;
a hexagonal fixing groove which is formed inside a fixture and into which an abutment is inserted;
a female screw part formed in the hexagonal fixing groove,
wherein the female screw part is configured to have a hexagonal internal shape, and a screw root of the female screw part is configured to be a circular screw part maintaining a circular shape such that one fixture may be used for two sorts of abutments regardless of the shape of the abutment which is configured to have a hexagonal shape or configured to be a circular screw part.

2. The fixture having a hexagonal female screw part according to claim 1, wherein the hexagonal fixing groove is divided into an upper portion and a lower portion, the hexagonal fixing groove is formed at the lower portion of the hexagonal fixing groove, and the female screw part is formed at the hexagonal fixing groove.

3. The fixture having a hexagonal female screw part according to claim 1, wherein a middle portion of an edge and an edge of a hexagonal shape of the female screw part has the longest screw thread.

4. The fixture having a hexagonal female screw part according to claim 1, wherein an edge of a hexagonal shape of the female screw part has the shortest screw thread.
